(19) United States
(12) Patent Application Publication
(10) Pub. No.: US 2004/0089519 A1
(43) Pub. Date: May 13, 2004

(54) Super drive conveyor belt

(75) Inventors: Eliezer Pollak, Shlomi (IL); Lior Shalel, Karmiel (IL); Moshe Rozenstein, Karmiel (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: VOLTA Belting Technology Ltd.

(21) Appl. No.: 10/290,511

(22) Filed: Nov. 8, 2002

(51) Int. Cl. B65G 23/06

(52) U.S. Cl. 198/834

(57) ABSTRACT

A conveyor belt system having a drive pulley and a closed belt. The drive pulley has a plurality of pulley teeth thereon. The drive pulley has an axis of rotation. The closed belt has a pulley side which faces the drive pulley. The closed belt has a plurality of belt teeth and a plurality of recesses on the pulley side. Each of the recesses has two sides and a base. The drive pulley is configured to rotate about the axis of rotation in order to propel the belt in a drive direction by at least one of the pulley teeth pushing a corresponding one of the sides of one of the recesses. In a cross-sectional view of the drive pulley and the belt taken in a plane which is perpendicular to the axis of rotation, the one pulley tooth only partially fills the one recess.

### FIELD AND BACKGROUND OF THE INVENTION

The present invention relates to a conveyor belt system and, in particular, it concerns a conveyor belt system for use in industries requiring high levels of cleanliness.

By way of introduction, flat conveyor belts move a product from one point to another by carrying the product along a pre-defined route or track. A conveyor belt system includes a flat belt which surrounds a drive pulley and a tail pulley. Conveyor belt motion is produced by rotation of the drive pulley. A load on the belt is evenly distributed along the contact surface of the pulleys. Flat homogeneous belts are used in conveyor systems where cleanliness is of paramount importance. The term “homogeneous belt” is an industry term that generally refers to a non-reinforced extruded belt or one made from a single material. These belts provide a smooth continuous surface which is non-absorbing and allows for easy cleaning of spilled contaminants or remains from the manufacturing process. These belts are not likely to be carrying foreign materials that might contaminate the product being conveyed. To ensure that the drive pulley can transfer sufficient force to drive the belt, the belt is pre-tensioned so that the friction between the belt and the drive pulley is sufficient to ensure that the belt does not slip against the surface of the drive pulley. While pre-tensioning ensures that the drive pulley will drive the belt, there are resultant unavoidable problems. Firstly, in the presence of oils, liquids and other lubricants and contaminants even a properly pre-tensioned belt will slip against the surface of the pulley, requiring the belt to be further tensioned. This additional tensioning damages the belt. Secondly, pre-tensioning by definition means stretching the belt. Homogeneous belts do stretch. However, stretched belts require regular pre-tensioning at regular intervals determined by the stretching force applied to the belts. Additionally, belt stretching necessitates belt replacement after the belt has exceeded its stretch limit. Thirdly, pre-tensioning also requires the additional cost associated with ensuring that the conveyor frame bed is strong enough to withstand the stress placed on it. Fourthly, improperly aligned belts will generally lead to damaged belt edges and a shorter belt life.

Of most relevance to the present invention is U.S. Pat. No. 5,911,307 to Kraft, et al. which describes a flat conveyor belt having a timing belt with teeth on the pulley side of the belt as well as teeth on the drive pulley itself. The patent to Kraft, et al. teaches that the teeth on the belt need to be a mirror image of the recess between the teeth on the drive pulley. The precision required between the timing belt and the drive pulley necessitates that the teeth fill the recesses completely. Therefore, any materials that come into contact with the drive pulley enter the recess and prevent the belt teeth from entering the recesses completely. This causes the belt to jump out of the pulley causing damage to the belt and loss of controlled drive between the drive pulley and the tail pulley.

Although modular plastic chains and belting of the prior art do meet the needs as far as positive drive and tracking are concerned, they are a haven for dirt, product residue, bacteria etc., and they are difficult, if not nearly impossible to clean quickly or efficiently.

Therefore, there is a need for a conveyor belt system which provides positive drive, prevents slippage, can move high loads, is not affected by contamination and sanitation is easily maintained.

### SUMMARY OF THE INVENTION

The present invention is a conveyor belt construction.

According to the teachings of the present invention there is provided, a conveyor belt system comprising: (a) a drive pulley having a plurality of pulley teeth thereon, the drive pulley having an axis of rotation; and (b) a closed belt having a pulley side which faces the drive pulley, wherein: (i) the closed belt has a plurality of belt teeth and a plurality of recesses on the pulley side, each of the recesses having two sides and one base; (ii) the drive pulley is configured to rotate about the axis of rotation in order to propel the belt in a drive direction by at least one of the pulley teeth pushing a corresponding one of the sides of one of the recesses; and (iii) in a cross-sectional view of the drive pulley and the closed belt taken in a plane which is perpendicular to the axis of rotation, the one pulley tooth only partially fills the one recess.

According to a further feature of the present invention, in the cross-sectional view the one pulley tooth fills up to 95% of the one recess.

According to a further feature of the present invention: (a) each of the pulley teeth has a pulley tooth width; (b) each of the recesses has a recess width; and (c) the pulley tooth width is less than the recess width.

According to a further feature of the present invention, the pulley tooth width does not exceed 95% of the recess width.

According to a further feature of the present invention: (a) each of the pulley teeth has a pulley tooth height; (b) each of the belt teeth has a belt tooth height; and (c) the belt tooth height is less than the pulley tooth height.

According to a further feature of the present invention, the belt tooth height does not exceed 95% of the pulley tooth height.

According to a further feature of the present invention, when the closed belt is not loaded, only one of the pulley teeth is in contact with one of the belt teeth.

According to a further feature of the present invention: (a) the pulley teeth have a pulley pitch; (b) the belt teeth have a belt pitch measured when the closed belt is flat; and (c) when the closed belt is not loaded the pulley pitch is greater than the belt pitch.

According to a further feature of the present invention, when the closed belt is not loaded the pulley pitch is at least 0.3% greater than the belt pitch.

According to a further feature of the present invention, the closed belt is made of a material having a low bacterial count.

According to a further feature of the present invention, the closed belt is made of plastic.

According to a further feature of the present invention, the closed belt is made of non-reinforced plastic.

According to a further feature of the present invention: (a) the closed belt has a width parallel to the axis of rotation; and (b) the closed belt is reinforced for at least a portion of the width which includes a region of the closed belt which has the belt teeth.

According to a further feature of the present invention: (a) the closed belt has a width parallel to the axis of rotation; and (b) the closed belt is reinforced for a whole of the width.

### BRIEF DESCRIPTION OF THE DRAWINGS

The invention is herein described, by way of example only, with reference to the accompanying drawings, wherein:

FIG. 1 is an isometric view of a conveyor belt system that is constructed and operable in accordance with a preferred embodiment of the invention;

FIG. 2 is a side view of the conveyor belt system of FIG. 1;

FIG. 3a is an isometric view of the pulley side of an non-reinforced conveyor belt for use with the conveyor belt system of FIG. 1;

FIG. 3b is an isometric view of the pulley side of a partially reinforced conveyor belt for use with the conveyor belt system of FIG. 1;

FIG. 3c is an isometric view of the pulley side of a fully reinforced conveyor belt for use with the conveyor belt system of FIG. 1;

FIG. 4a is an isometric view of a drive pulley for use with the conveyor belt system of FIG. 1;

FIG. 4b is an isometric view of a drive pulley for use with the conveyor belt system of FIG. 1 wherein the drive pulley width is the width of the teeth of the conveyor belt;

FIG. 4c is an isometric view of another drive pulley for use with the conveyor belt system of FIG. 1;

FIG. 4d is an isometric view of an alternate drive pulley for use with the conveyor belt system of FIG. 1; and

FIG. 5 is an isometric view of a tail pulley for use with the conveyor belt system of FIG. 1.

### DESCRIPTION OF THE PREFERRED EMBODIMENTS

The present invention is a conveyor belt system construction and method of operation thereof.

The principles and operation of the conveyor belt system according to the present invention may be better understood with reference to the drawings and the accompanying description.

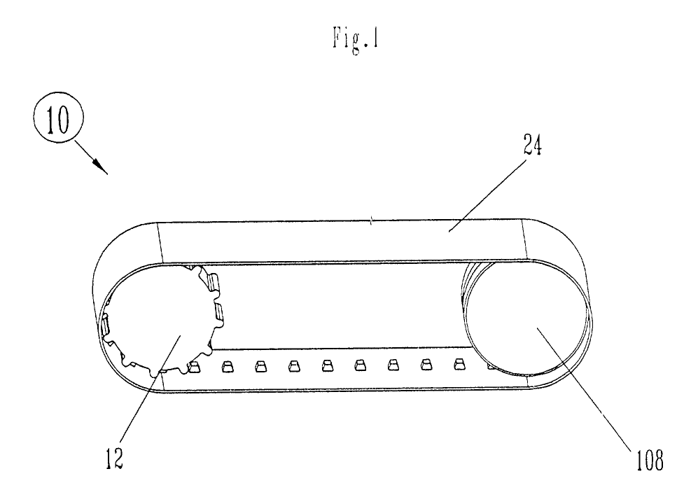

Reference is now made to FIG. 1, which is an isometric view of a conveyor belt system 10 that is constructed and operable in accordance with a preferred embodiment of the invention Conveyor belt system 10 includes a drive pulley 12, a tail pulley 108 and a closed belt 24.

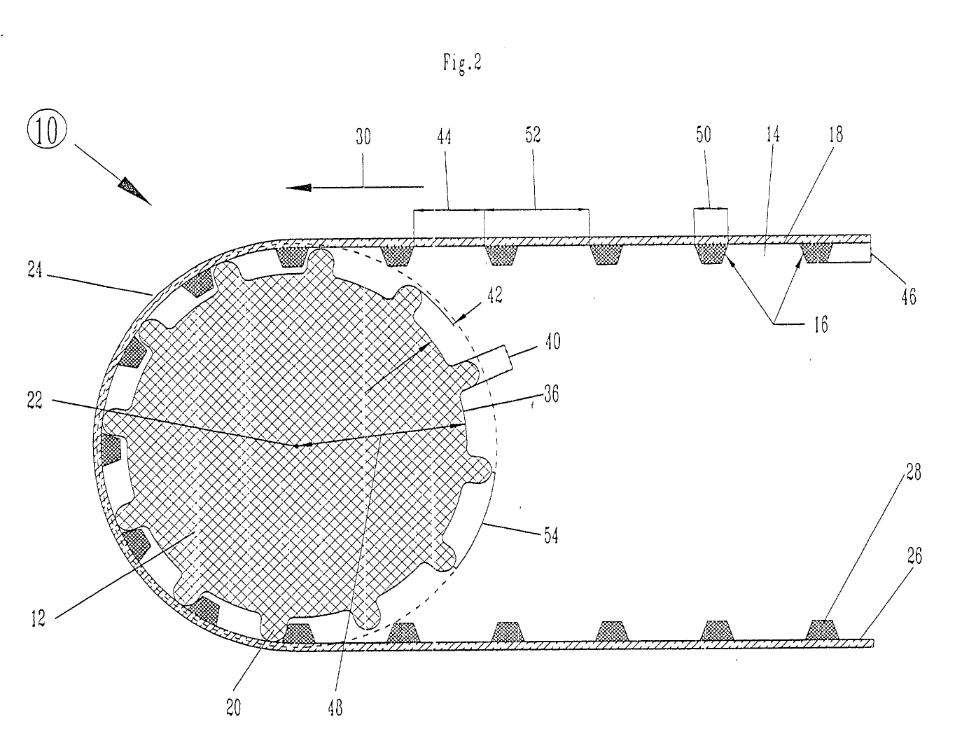

Reference is now made to FIG. 2, which is a side view of conveyor belt system 10. Drive pulley 12 a plurality of teeth 20 thereon. Drive pulley 12 has an axis of rotation 22. Closed belt 24 has a pulley side 26 which faces drive pulley 12. Closed belt 24 has a plurality of teeth 28 and a plurality of recesses 14 on pulley side 26. Each of recesses 14 has two sides 16 and a base 18. Sides 16 of two adjacent recesses 14 form one of teeth 20. It should be noted that two sides 16, which form one of teeth 28 do not necessarily need to be the same and therefore the teeth are not necessarily symmetrical. It should also be noted that closed belt 24, teeth 28 and recesses 14 are generally either formed by the addition of teeth 28 to closed belt 24 or by forming teeth 28 from closed belt 24 by an extrusion process. Drive pulley 12 is generally driven by a mechanical means (not shown). Drive pulley 12 is configured to rotate about axis of rotation 22 in order to propel closed belt 24 in a drive direction 30 by one or more of teeth 20 pushing a corresponding one of sides 16 of one of recesses 14 of closed belt 24. In other words, one or more teeth 20 of drive pulley 12 propel closed belt 24 by pushing a corresponding one of teeth 28. It should be noted that recesses 14 may be formed such that the region where base 18 ends and sides 16 begin is unclear. For example, the joint between base 18 and sides 16 may be curved. However, even in such a case, recesses 14 are still described as having base 18 and sides 16 where sides 16 are the portion of recesses 14 which are used by teeth 20 to push closed belt 24. In a cross-sectional view of a drive pulley 12 and closed belt 24 taken in a plane which is perpendicular to axis of rotation 22, one of teeth 20 of drive pulley 12 which is in meshing with closed belt 24 only partially fills one of recesses 14. Alternatively, teeth 28 only partially fill the recesses between teeth 20 of drive pulley 12. Therefore, if the recesses on drive pulley 12, between teeth 20, become filled with grease and/or other dirt, teeth 28 are not pushed out of the recesses between teeth 20 on drive pulley 12 which would cause damage to closed belt 24. It should be noted that typically, the dimensions of teeth 20 and recesses 14 are such that in the cross-sectional view of a drive pulley 12 and closed belt 24, one of teeth 20 fills up to 95% of one of recesses 14. Typically, the symmetry of teeth 28 of closed belt 24 is a mirror image of the symmetry of teeth 20 of drive pulley 12. However, teeth 20 of drive pulley 12 are not mirror images of recesses 14 on closed belt 24. Therefore, a width 40 of teeth 20 is less than a width 44 of recesses 14 and/or a height 46 of recesses 14, which is the height of teeth 28, is less than a height 42 of teeth 20. Height 42 of teeth 20 is measured from a drive pulley inner surface 36 to the highest point of teeth 20 along a radius 48 of drive pulley inner surface 36. Width 40 of teeth 20 is measured as a straight line between two points of teeth 20 where teeth 20 meet drive pulley inner surface 36. Width 44 of recesses 14 is measured at the surface of closed belt 24 when closed belt 24 is flat. Height 46 of recesses 14, which is equal to the height of teeth 28, is measured from pulley side 26 of closed belt 24 to the highest point of teeth 28. A width 50 of teeth 28 is taken at the surface of closed belt 24 when closed belt 24 is flat. It should be noted, that typically, width 40 of teeth 20 does not exceed 95% of width 44 of recesses 14 and height 46 of teeth 28 does not exceed 95% of height 42 of teeth 20. Therefore, the larger size of recesses 14 as compared to teeth 20 allows for easy removal of excess material from a drive pulley 12 and closed belt 24 during conveyor operation. In addition, teeth 20 of a drive pulley 12 engage teeth 28 of closed belt 24 to push closed belt 24 in drive direction 30 providing positive drive. In accordance with a preferred embodiment of the present invention, the teeth have a trapezoidal cross-section. However, teeth of any shape may be used, including, but not limited to: rectangular, square, trapezoidal and curved or any combination thereof. The following relationships give the typical preferred range of values for the dimensions and pitch of teeth 20 of drive pulley 12 and teeth 28 of closed belt 24.

X/Wp=1 to 20 Relationship (1),

where X is width 44 of recesses 14 and Wp is width 40 of teeth 20 of drive pulley 12.

H_{P}/H_{B}=1 to 2 Relationship (2),

where H_{B} is height 46 of teeth 28 and Hp is height 42 of teeth 20.

P_{P}/P_{B}=1 to 1.03 Relationship (3),

where P_{B} is a pitch 52 of teeth 28 on closed belt 24 and P_{P} is a pitch 54 of teeth 20 on drive pulley 12. The term pitch refers to the distance between the teeth as measured from a consistent point using calculation methods and definitions known to those skilled in the art. In accordance with an optional embodiment of the present invention, when closed belt 24 is not loaded, pitch 54 is greater than pitch 52. In other words, in accordance with this optional embodiment, when closed belt 24 is not loaded, only one of teeth 20 is in contact with one of teeth 28. This difference between pitch 54 and pitch 52 is to allow for stretching of closed belt 24 when a load is placed on conveyor belt system 10 or for other reasons. Therefore, in accordance with this optional embodiment, to allow for stretching of closed belt 24, pitch 54 is preferably bewtween 0.3% to 3% greater than pitch 52 when closed belt 24 is not loaded.

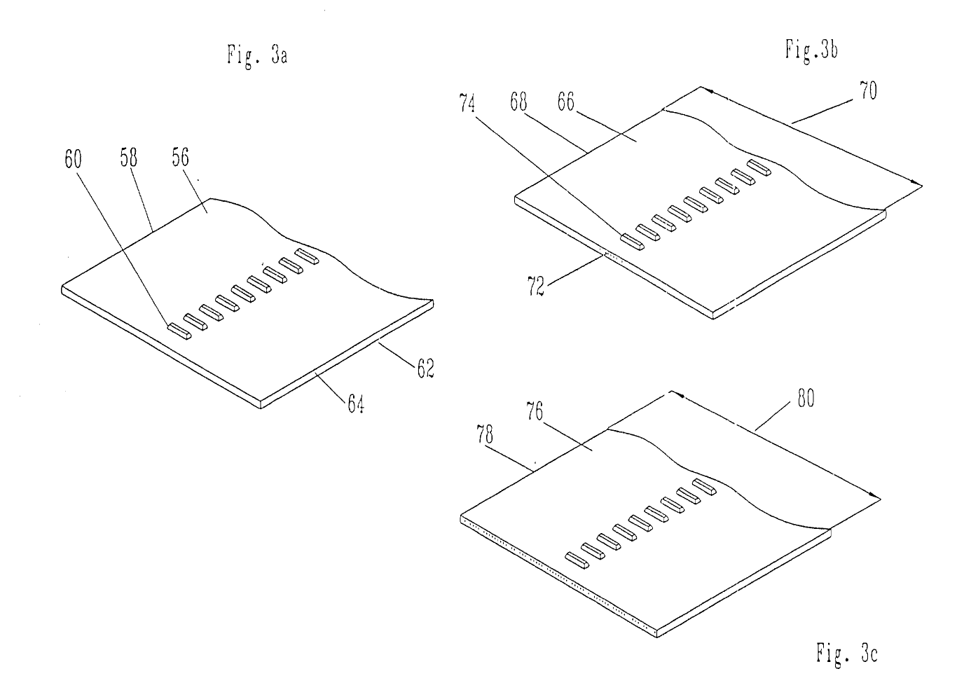

Reference is now made to FIG. 3a, which is an isometric view of a pulley side 56 of an non-reinforced conveyor belt 58 for use with conveyor belt system 10. It should be noted that non-reinforced conveyor belt 58 has a plurality of teeth 60. Teeth 60 are generally larger than the teeth associated with prior art timing belts. Non-reinforced conveyor belt 58 is made of solid non-reinforced plastic without any fabric and provides a low bacteria count. VOLTA Belting Technology Ltd. of Karmiel Industrial Park, Israel provides a belt that satisfies the requirements of the present invention. Non-reinforced conveyor belt 58 has a topside 62 and outer edges 64, which provide a smooth surface that may be easily cleaned and maintained.

Reference is now made to FIG. 3b, which is an isometric view of a pulley side 66 of a partially reinforced conveyor belt 68 for use with conveyor belt system 10. Belt 68 has a plurality of teeth 74 and a width 70 parallel to axis of rotation 22 of drive pulley 12. Belt 68 is reinforced along its length for at least a portion of width 70 which includes a region 72 of belt 68 which has teeth 74. VOLTA Belting Technology Ltd. of Karmiel Industrial Park, Israel provides a belt that satisfies the requirements of the present invention.

Reference is now made to FIG. 3c, which is an isometric view of a pulley side 76 of a fully reinforced conveyor belt 78 for use with conveyor belt system 10. Belt 78 has a width 80 parallel to axis of rotation 22 of drive pulley 12. Belt 78 is reinforced along its length for the whole of width 80. VOLTA Belting Technology Ltd. of Karmiel Industrial Park, Israel provides a belt that satisfies the requirements of the present invention The belts referred to with respect to FIGS. 3a, 3b and 3c are typically produced by extrusion processes. It will be apparent to a person skilled in the art of belt manufacture how to produce the belts of FIGS. 3a, 3b and 3c.

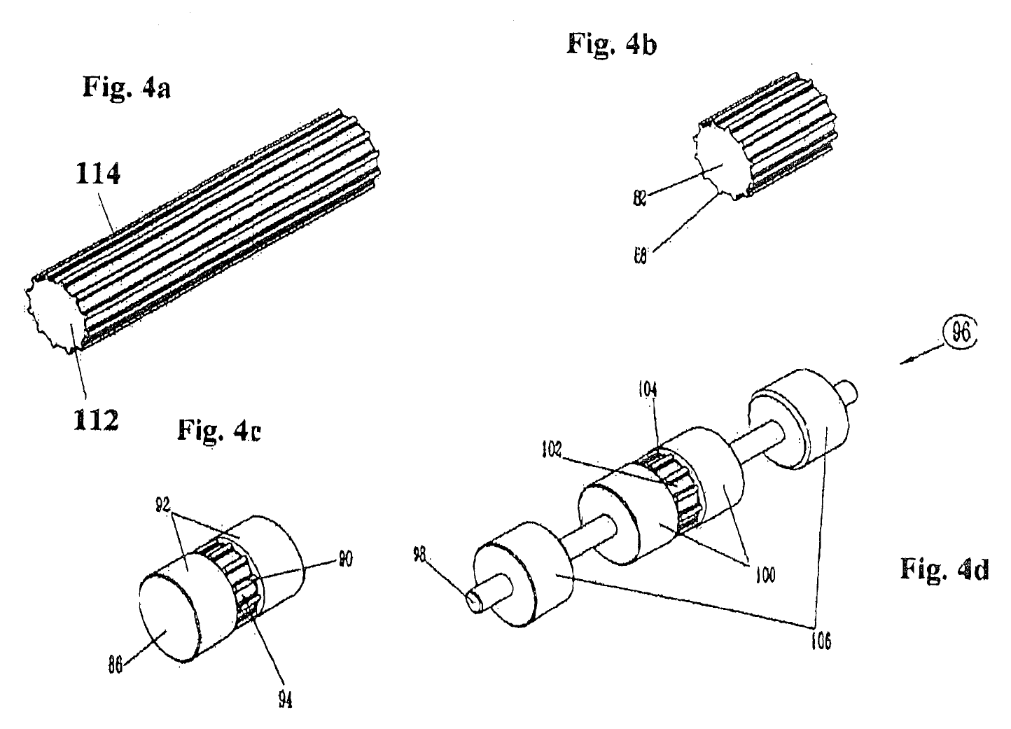

Reference is now made to FIG. 4a, which is an isometric view of a drive pulley 112 for use with conveyor belt system 10. Drive pulley 112 has a plurality of teeth 114 which extend the full length of drive pulley 112. The length of drive pulley 112 is equal to the width of closed belt 24.

Reference is now made to FIG. 4b, which is an isometric view of a drive pulley 82 for use with conveyor belt system 10. Drive pulley 82 has a plurality of teeth 88 which extend the full length of drive pulley 82. The length of drive pulley 82 is equal to the length of teeth 28 of closed belt 24, wherein the length of teeth 28 is measured parallel to the axis of drive pulley 82. It should be noted that drive pulley 112 and drive pulley 82 represent examples of possible embodiments of the drive pulley for conveyor belt system 10. However, the length of the drive pulley for use with conveyor belt system 10 may have any length within a range between that of drive pulley 112 and drive pulley 82.

Reference is now made to FIG. 4c, which is an isometric view of another drive pulley 86 for use with conveyor belt system 10. Drive pulley 86 has three cylindrical portions, two outer portions which are smooth cylinders 92 and a central portion 94 which has teeth 90. The top of teeth 90 are level with the outside surfaces of smooth cylinders 92.

Reference is now made to FIG. 4d, which is an isometric view of an alternate drive pulley 96 for use with conveyor belt system 10. Drive pulley 96 has five cylindrical portions which are mechanically connected by a central axle 98. A central portion 102 which has teeth 104 is sandwiched between two smooth cylinders 100. Two outer portions which are smooth cylinders 106 are spaced apart from smooth cylinders 100.

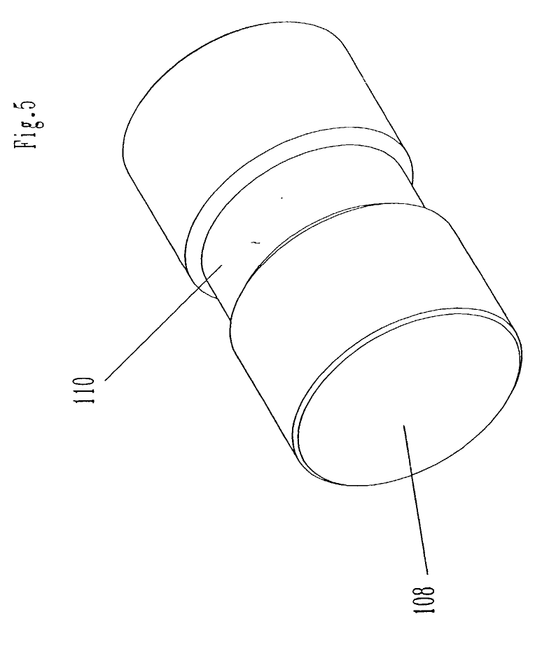

Reference is now made to FIG. 5, which is an isometric view of tail pulley 108. Tail pulley 108 may or may not have teeth depending on the specific application. When tail pulley 108 does not have teeth it is constructed to have a groove 110 cut around its circumference to allow for passage of teeth 28 of closed belt 24.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description. In particular, the above description refers specifically to homogeneous type conveyor belts, however, the invention is equally applicable to a multi-layer, reinforced or other design of conveyor belt

What is claimed is:

1. A conveyor belt system comprising:
(a) a drive pulley having a plurality of pulley teeth thereon, said drive pulley having an axis of rotation; and
(b) a closed belt having a pulley side which faces said drive pulley, wherein:
(i) said closed belt has a plurality of belt teeth and a plurality of recesses on said pulley side, each of said recesses having two sides and one base;
(ii) said drive pulley is configured to rotate about said axis of rotation in order to propel said belt in a drive direction by at least one of said pulley teeth pushing a corresponding one of said sides of one of said recesses; and
(iii) in a cross-sectional view of said drive pulley and said closed belt taken in a plane which is perpendicular to said axis of rotation, said one pulley tooth only partially fills said one recess.

2. The conveyor belt system of claim 1, wherein in said cross-sectional view said one pulley tooth fills up to 95% of said one recess.

3. The conveyor belt system of claim 1, wherein:
(a) each of said pulley teeth has a pulley tooth width;
(b) each of said recesses has a recess width; and
(c) said pulley tooth width is less than said recess width.

4. The conveyor belt system of claim 3, wherein said pulley tooth width does not exceed 95% of said recess width.

5. The conveyor belt system of claim 1, wherein:
(a) each of said pulley teeth has a pulley tooth height;
(b) each of said belt teeth has a belt tooth height; and
(c) said belt tooth height is less than said pulley tooth height.

6. The conveyor belt system of claim 5, wherein said belt tooth height does not exceed 95% of said pulley tooth height.

7. The conveyor belt system of claim 1, wherein when said closed belt is not loaded, only one of said pulley teeth is in contact with one of said belt teeth.

8. The conveyor belt system of claim 1, wherein:
(a) said pulley teeth have a pulley pitch;
(b) said belt teeth have a belt pitch measured when said closed belt is flat; and
(c) when said closed belt is not loaded said pulley pitch is greater than said belt pitch.

9. The conveyor belt system of claim 8, wherein when said closed belt is not loaded said pulley pitch is at least 0.3% greater than said belt pitch.

10. The conveyor belt system of claim 1, wherein said closed belt is made of a material having a low bacterial count.

11. The conveyor belt system of claim 1, wherein said closed belt is made of plastic.

12. The conveyor belt system of claim 11, wherein said closed belt is made of non-reinforced plastic.

13. The conveyor belt system of claim 1, wherein:
(a) said closed belt has a width parallel to said axis of rotation; and
(b) said closed belt is reinforced for at least a portion of said width which includes a region of said closed belt which has said belt teeth.

14. The conveyor belt system of claim 1, wherein:
(a) said closed belt has a width parallel to said axis of rotation; and
(b) said closed belt is reinforced for a whole of said width.
